(19) United States
(12) Patent Application Publication
(10) Pub. No.: US 2013/0049431 A1
(43) Pub. Date: Feb. 28, 2013

(54) SEAT ASSEMBLY FOR A VEHICLE

(71) Applicant: Roger Terence Arthur MEDWELL, Coventry (GB)

(72) Inventor: Roger Terence Arthur MEDWELL, Coventry (GB)

(21) Appl. No.: 13/398,115

(22) Filed: Feb. 16, 2012

(30) Foreign Application Priority Data
Feb. 24, 2011 (GB) 1103202.6

(51) Int. Cl. B60N 2/005; B60N 2/44

(52) U.S. Cl. 297/452.1

(57) ABSTRACT

A vehicle seat assembly comprises a seat and at least one flexible strap for suspending the seat from a part of the vehicle or of the seat assembly. A pad of compressible foam is arranged to be interposed between a surface of the seat facing away from an occupant and a vehicle hull.

This Application claims the benefit of the priority of U.K. Patent Application Number 1103202.6 filed Feb. 24, 2011, entitled “SEAT ASSEMBLY FOR A VEHICLE”, which is hereby incorporated herein by reference in its entirety.

The present invention relates to a seat assembly for a vehicle for use by security and defense forces.

### BACKGROUND TO THE INVENTION

A known seat is formed from metal. When a vehicle is penetrated by a projectile or blast wave, parts or components of the seat itself can injure or even kill occupants.

### SUMMARY OF THE INVENTION

The present invention provides a vehicle seat assembly comprising a seat, at least one flexible strap for suspending the seat from a part of the vehicle or of the seat assembly, and a pad of compressible foam arranged to be interposed between a surface of the seat facing away from an occupant and a vehicle hull.

In a particular embodiment of the invention, no structural part of the seat assembly is metallic. Thus, where the vehicle hull is non-metallic, there is no structural metal between an occupant and a threat.

Flexible straps may be provided at both a top part and a bottom part of the seat. The assembly may comprise a protective panel, for example of ultra high molecular weight polyethylene fiber, mountable to the inside of the vehicle hull. The straps may be attached to the panel or may extend through apertures in the panel to an anchorage behind the panel.

The pad of compressible material, for example closed cell polyethylene, polyurethane or polystyrene foam, may be attached to a back of the seat.

In another aspect, a seat assembly for a vehicle may comprise: a seat having a first surface for receiving an occupant and a second surface for facing away from an occupant; a flexible strap for suspending the seat from a vehicle; and a foam pad of compressible foam disposed adjacent the second surface of the seat for facing toward the vehicle.

In a further aspect, a seat assembly for a vehicle may comprise: a non-metallic seat having a first surface for receiving an occupant and a second surface for facing away from an occupant; a non-metallic protective panel interposed between the non-metallic seat and the vehicle; flexible straps for suspending the seat from the non-metallic protective panel or from the vehicle through apertures in the protective panel, with the second surface facing the protective panel, and a foam pad of compressible foam disposed adjacent the second surface of the seat and facing the protective panel.

### BRIEF DESCRIPTION OF THE DRAWING

The detailed description of the preferred embodiment(s), by way of example only, will be more easily and better understood when read in conjunction with the accompanying FIGURES of the Drawing which include:

FIG. 1 is a schematic sectional view of an example seat assembly according to an embodiment of the invention; and

FIG. 2 is a perspective view of the example seat assembly of FIG. 1.

In the Drawing, where an element or feature is shown in more than one drawing figure, the same alphanumeric designation may be used to designate such element or feature in each figure. According to common practice, the various features of the drawing are not to scale, and the dimensions of the various features may be arbitrarily expanded or reduced for clarity.

### DESCRIPTION OF THE PREFERRED EMBODIMENT(S)

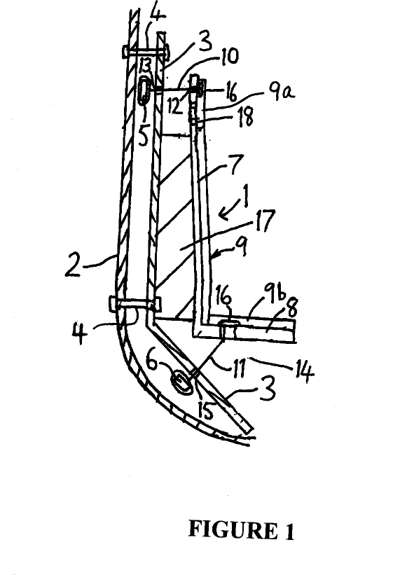

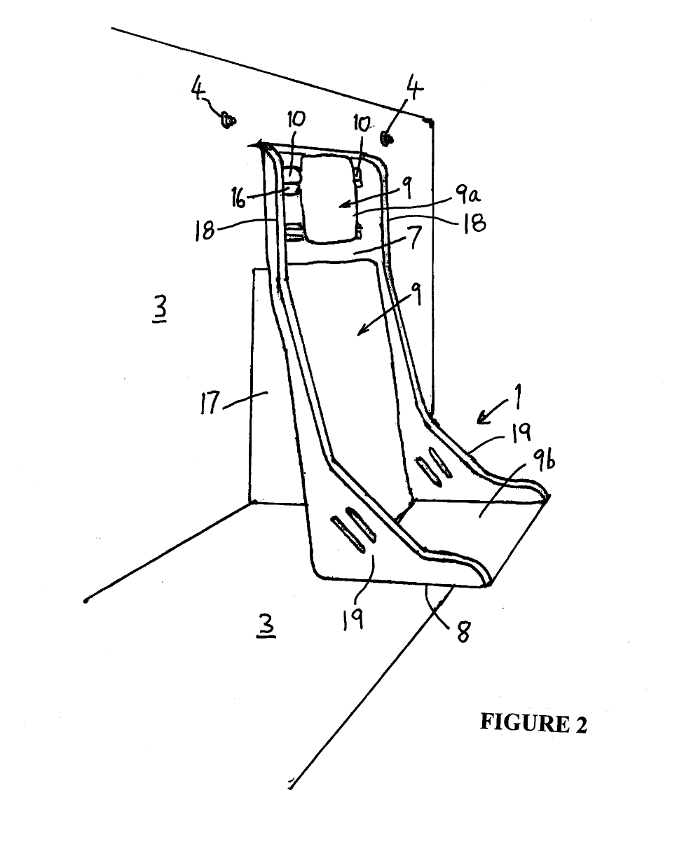

FIGS. 1 and 2 of the drawings show a seat assembly comprising a seat 1 fixed to the inside of a vehicle hull 2. A non-metallic spall armor panel 3 is attached to the hull 2, in this example by means of bolts 4 which are arranged at heights not coinciding with the seat 1. The armor panel 3 can be of ultra height molecular weight polyethylene, such as Dyneema® polyethylene which is available from Royal DSM NV of Heerlen, Netherlands. In this example, the armor panel 3 conforms to the shape of the vehicle hull 2 so that a lower part of the panel 3 is at an angle to the main upper part thereof.

A horizontal upper bar 5 is mounted behind the armor panel 3 near its upper edge, and a horizontal lower bar 6 is mounted behind the armor panel 3 near its lower edge. In this example the bars 5, 6 are preferably of carbon fiber.

The seat 1 is preferably formed from a non-metallic material, in this example from S-2 Glass® fiber from AGY of Aiken, S.C., USA. The seat has a seat back 7 and a seating portion 8. The seat can be provided with one or more cushions 9, for example, at the seating portion and the back and at a head location.

The seat 1 is suspended by straps 10, 11 preferably in the form of nylon webbing. Two upper straps 10 pass though respective apertures 12 near the top of the seat back 7, through upper panel apertures 13 in the panel 3 and around the anchoring upper bar 5. Two lower straps 11 pass through respective lower apertures 14 in the seating portion 8, through lower panel apertures 15 in the lower part of the panel 3 and around the lower anchoring bar 6. The straps 10, 11 can be anchored to the seat 1 by means of buckles 16.

Horizontal anchoring bars 5, 6 may be attached to the vehicle 2 or may be supported by armor panel 3 which is attached to the vehicle 2 by bolts 4, and so seat 1 may be supported by strap 10, 11 directly or indirectly from a part of the vehicle 2. The bars 5, 6 can be long enough to anchor a plurality of seats 1 arranged in a row thereby.

A compressible pad 17, which can be formed of closed cell polyethylene, polyurethane or polystyrene foam, is preferably bonded to the outside of the seat back 7 and is therefore interposed between the seat 1 and the armor panel 3. The pad 17 can be profiled, e.g. tapering upwardly if the seat has a sloping back 7.

The seat is provided with further apertures 18 in its back 7 and sides for attaching a seat belt or a harness.

There is no structural metal in the seat assembly, thus preventing the creation of secondary metallic projectiles in the event of an overmatching blast or impact.

Injuries in the event of a blast in known vehicles are often caused by rapid acceleration of an occupant's torso. In the present invention, such acceleration is reduced by flexing of the composite vehicle hull 2, flexing of the spall panel 3, stretching of the straps 10, 11 and flexing of the seat 1 itself. Most significantly such acceleration of the torso is reduced by compression of the compressible pad 17. The thickness of the pad and density of the foam can be selected to optimize this performance.

A vehicle seat assembly may comprise a seat 1, at least one flexible strap 10, 11 for suspending the seat 1 from a part of the vehicle 2, or of the seat assembly, and a pad 17 of compressible foam arranged to be interposed between a surface of the seat 1 facing away from an occupant and a vehicle hull 2. No structural part of the seat assembly may be metallic. The flexible straps 10, 11 for suspending the seat 1 may be provided at both a top part and a bottom part of the seat 1. The seat assembly may comprise a protective panel 3, mountable to the inside of the vehicle hull 2. The protective panel 3 may be of ultra high molecular weight polyethylene fiber. The straps 10, 11 may be attached to the protective panel 3. The straps 10, 11 may extend through apertures in the protective panel 3 to at least one anchorage behind the protective panel 3. The at least one anchorage may be in the form of a horizontal bar 5, 6. The pad 17 of compressible material may be of closed cell polyethylene, polyurethane or polystyrene foam, and the pad 17 of compressible material may be attached to a back of the seat 1.

A seat assembly for a vehicle 2 may comprise: a seat 1 having a first surface for receiving an occupant and a second surface for facing away from an occupant; a flexible strap 10, 11 for suspending the seat 1 from a vehicle 2; and a foam pad 17 of compressible foam disposed adjacent the second surface of the seat 1 for facing toward the vehicle 2. The seat assembly may further comprise: a protective panel 3 interposed between the foam pad 17 and the vehicle 2, wherein: the protective panel 3 may be mounted to the vehicle 2 and the seat 1 may be suspended by the flexible strap 10, 11 from the protective panel 3, or the seat 1 may be suspended by the flexible strap 10, 11 from the vehicle 2 through an aperture in the protective panel 3. The protective panel 3 may include an ultra high molecular weight polyethylene fiber. The flexible strap 10, 11 may include flexible straps 10, 11 attached to the seat at an upper portion thereof and at a lower portion thereof. The flexible straps 10, 11 may be attached to a protective panel 3 mounted to the vehicle 2, or may extend through apertures in a protective panel 3 to at least one anchorage between the protective panel 3 and the vehicle 2. The at least one anchorage may include: at least one horizontal bar 5, 6, or carbon fiber, or at least one horizontal carbon fiber bar 5, 6. The at least one anchorage may include: at least one horizontal bar 5, 6 supported by the vehicle 2; or at least one horizontal bar 5, 6 supported by the protective panel 3. The seat 1 may include glass fiber; or the foam pad 17 may include closed cell polyethylene foam, closed cell polyurethane foam or closed cell polystyrene foam, or the seat 1 may include glass fiber and the foam pad 17 may include closed cell polyethylene foam, closed cell polyurethane foam or closed cell polystyrene foam.

A seat assembly for a vehicle 2 may comprise: a non-metallic seat 1 having a first surface for receiving an occupant and a second surface for facing away from an occupant; a non-metallic protective panel 3 interposed between the non-metallic seat 1 and the vehicle 2; flexible straps 10, 11 for suspending the seat 1 from the non-metallic protective panel 3 or from the vehicle 2 through apertures in the protective panel 3, with the second surface facing the protective panel 3, and a foam pad 17 of compressible foam disposed adjacent the second surface of the seat 1 and facing the protective panel 3. The flexible straps 10, 11 may extend through apertures in a protective panel 3 to one or more horizontal bars 5, 6 between the protective panel 3 and the vehicle 2, wherein the one or more horizontal bars 5, 6 may be supported by the vehicle 2 or by the protective panel 3.

Although terms such as “upper,” “lower,” “left,” “right,” “front,” “rear,” “side,” “top,” “bottom,” “forward,” “backward,” “under” and/or “over,” and the like may be used herein as a convenience in describing one or more embodiments and/or uses of the present arrangement, the articles described may be in any desired orientation and/or may be utilized in different positions and/or orientations. Such terms should be understood as not limiting of the invention as claimed.

While the present invention has been described in terms of the foregoing example embodiments, variations within the scope and spirit of the present invention as defined by the claims following will be apparent to those skilled in the art. For example, the seat could have lateral head restraints 18 and/or side portions 19. In one example embodiment, the straps 10, 11 in the form of nylon webbing are replaced by ropes or cords.

A head portion 9a of cushion 9 may be separate from the main portion 9b thereof.

The protective armor panel 3 may be part of the vehicle or may be part of the seat assembly, and the horizontal bars 5, 6 may be anchored to the vehicle 2 or a part thereof or may be supported by the protective armor panel 3.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A vehicle seat assembly comprising a seat, at least one flexible strap for suspending the seat from a part of the vehicle, and a pad of compressible foam arranged to be interposed between a surface of the seat facing away from an occupant and a vehicle hull.

2. A seat assembly according to claim 1, wherein no structural part of the seat assembly is metallic.

3. A seat assembly according to claim 1, wherein flexible straps for suspending the seat are provided at both a top part and a bottom part of the seat.

4. A seat assembly according to claim 1, comprising a protective panel, mountable to the inside of the vehicle hull.

5. A seat assembly according to claim 4, wherein the protective panel is of ultra high molecular weight polyethylene fiber.

6. A seat assembly according to claim 4, wherein the straps are attached to the protective panel.

7. A seat assembly according to claim 4, wherein the straps extend through apertures in the protective panel to at least one anchorage behind the protective panel.

8. A seat assembly according to claim 7, wherein the at least one anchorage is in the form of a horizontal bar.

9. A seat assembly according to claim 1, wherein the pad of compressible material is of closed cell polyethylene, polyurethane or polystyrene foam.

10. A seat assembly according to claim 1, wherein the pad of compressible material is attached to a back of the seat.

11. A seat assembly for a vehicle comprising:
a seat having a first surface for receiving an occupant and a second surface for facing away from an occupant;
a flexible strap for suspending the seat from a vehicle; and
a foam pad of compressible foam disposed adjacent the second surface of the seat for facing toward the vehicle.

12. The seat assembly of claim 11, further comprising:
a protective panel interposed between the foam pad and the vehicle, wherein:
the protective panel is mounted to the vehicle and the seat is suspended by the flexible strap from the protective panel, or
the seat is suspended by the flexible strap from the vehicle through an aperture in the protective panel.

13. The seat assembly of claim 12, wherein the protective panel includes an ultra high molecular weight polyethylene fiber.

14. The seat assembly of claim 11, wherein the flexible strap includes flexible straps attached to the seat at an upper portion thereof and at a lower portion thereof.

15. The seat assembly of claim 14, wherein:
the flexible straps are attached to a protective panel mounted to the vehicle, or
the flexible straps extend through apertures in a protective panel to at least one anchorage between the protective panel and the vehicle.

16. The seat assembly of claim 15, wherein the at least one anchorage includes:
at least one horizontal bar, or
carbon fiber, or
at least one horizontal carbon fiber bar.

17. The seat assembly of claim 15, wherein the at least one anchorage includes:
at least one horizontal bar supported by the vehicle; or
at least one horizontal bar supported by the protective panel.

18. The seat assembly of claim 11, wherein:
the seat includes glass fiber; or
the foam pad includes closed cell polyethylene foam, closed cell polyurethane foam or closed cell polystyrene foam, or
the seat includes glass fiber and the foam pad includes closed cell polyethylene foam, closed cell polyurethane foam or closed cell polystyrene foam.

19. A seat assembly for a vehicle comprising:
a non-metallic seat having a first surface for receiving an occupant and a second surface for facing away from an occupant;
a non-metallic protective panel interposed between the non-metallic seat and the vehicle;
flexible straps for suspending the seat from the non-metallic protective panel or from the vehicle through apertures in the protective panel, with the second surface facing the protective panel, and
a foam pad of compressible foam disposed adjacent the second surface of the seat and facing the protective panel.

20. The seat assembly of claim 19, wherein the flexible straps extend through apertures in a protective panel to one or more horizontal bars between the protective panel and the vehicle, wherein the one or more horizontal bars are supported by the vehicle or by the protective panel.
